(19) United States
(12) Patent Application Publication
(10) Pub. No.: US 2025/0265597 A1
(43) Pub. Date: Aug. 21, 2025

(54) Embedding Carbon Offset Credits in Digital Certificates

(71) Applicant: DigiCert, Inc., Lehi, UT (US)

(72) Inventors: Shivan Naidoo, Cape Town (ZA); Avesta Hojjati, Austin, TX (US)

(73) Assignee: DigiCert, Inc., Lehi, UT (US)

(21) Appl. No.: 18/582,816

(22) Filed: Feb. 21, 2024

(51) Int. Cl. G06Q 30/018; H04L 9/32

(52) U.S. Cl. CPC G06Q 30/018; H04L 9/3268

(57) ABSTRACT

Systems and methods are provided for embedding information regarding carbon emissions, carbon offsets, and carbon offset credits into a digital certificate, such as an X.509 certificate. According to one implementation, a method includes a step of computing an environmental account balance for an organization, where the environmental account balance is defined as a difference between offset credits and environmental deficits. For example, the offset credits represent countermeasures by the organization to offset negative effects of emissions of environmentally harmful gases. The environmental deficits represent emissions of environmentally harmful gases for which the organization is liable. Furthermore, the method includes a step of creating a digital certificate for the organization reflecting information pertaining to the environmental account balance.

### FIELD OF THE DISCLOSURE

The present disclosure generally pertains to the field of digital certificates, namely X.509 certificates. More particularly, the present disclosure pertains to systems and methods for embedding environmental carbon offset credits within X.509 digital certificates.

### BACKGROUND

Government agencies throughout the world, along with environmentally conscientious organizations, have instituted various regulations concerning the emission of certain types of gases into the Earth's atmosphere that can be harmful to the environment, causing global warming and severe weather events. For example, a list of environmentally harmful gases (often referred to as “greenhouse gases”) may include carbon monoxide (CO), carbon dioxide (CO₂), methane (CH₄), nitrous oxide (N₂O), ozone (O₃), chlorofluorocarbons, hydrofluorocarbons, perfluorocarbons, among others. One policy for regulating these “carbon emissions” includes a trading mechanism called “carbon offsetting” that allows entities such as governments, individuals, or businesses to compensate for or offset their emissions by supporting projects that reduce, avoid, or remove emissions elsewhere. A “carbon offset credit” (sometimes referred to as a “carbon credit” or “offset credit”) is a transferable financial instrument, which is a derivative of an underlying commodity having a certain market value that can be bought or sold in a cap-and-trade type of system. In some respects, the current system lacks fair and trustworthy regulations with respect to keeping track of positive and negative environmental influences. Also, there is currently no reliable way to verify a company's claims regarding their positive environmental influences, green initiatives, and sustainability policies.

### BRIEF SUMMARY

The present disclosure relates to systems and methods for issuing digital certificates, particularly digital certificates that are embedded with information about carbon offset credits, for providing authentication regarding a company's actual environmental responsibleness. According to one implementation, a method includes the step of computing an environmental account balance for an organization, where the environmental account balance is defined as a difference between offset credits and environmental deficits. The offset credits, for example, represent countermeasures by the organization to offset negative effects of emissions of environmentally harmful gases. Also, the environmental deficits represent emissions of environmentally harmful gases for which the organization is liable. Furthermore, the method may include the step of creating a digital certificate for the organization reflecting information pertaining to the environmental account balance.

In some embodiments, the information pertaining to the environmental account balance may include a carbon offset surplus configured as a digital asset having market or trade value. Also, the method may include a step of adding an identifier in the digital certificate that references one or more decentralized digital ledgers verifying the environmental account balance. According to some embodiments, the method may be performed by the certification system that works in collaboration with one or more environment monitoring systems for monitoring and/or enforcing policies regarding emissions of the environmentally harmful gases.

The environmental deficits may be defined by a carbon dioxide equivalent (CO2e) metric. The environmentally harmful gases, for example, may include carbon dioxide and/or so-called “greenhouse gases.” In some embodiments, the method may further include a step of issuing the digital certificate to an admin device associated with the organization. The digital certificate, for example, may be accompanied by one or more seals, marks, badges, or QR codes allowing the organization to showcase third-party verification of their commitment to environmental responsibility and green initiatives.

The digital certificate, according to some implementations, may be further configured for authenticating identity and/or security of the organization. In this case, the method may include a step of embedding the information pertaining to the environmental account balance into the digital certificate thereby extending the utility of the digital certificate. In other embodiments, the digital certificate may be a carbon offset credit certificate and/or may be created in accordance with X.509 policies.

In various embodiments, the present disclosure includes a) methods having the above-mentioned steps, b) processing devices configured to implement the above-mentioned steps, c) cloud services configured to implement the above-mentioned steps, and d) non-transitory computer-readable media storing instructions for programming one or more processors to execute the above-mentioned steps.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram illustrating a communications system in which digital certificates associated with carbon offset credits are issued to a number of organizations, according to various embodiments of the present disclosure.

FIG. 2 is a block diagram illustrating the certification system shown in FIG. 1, according to various embodiments.

FIG. 3 is a block diagram illustrating processing modules of the carbon credit certification program shown in FIG. 2, according to various embodiments.

FIG. 4 is a diagram illustrating an environmental account balance, according to various embodiments.

FIGS. 5A-5F are seals or marks for indicating information associated with carbon offset credits, according to various embodiments.

FIG. 6 is a flow diagram illustrating a method for embedding carbon offset credits in a digital certificate, according to various embodiments.

### DETAILED DESCRIPTION

Again, the present disclosure relates to systems and methods for monitoring the activities and operations of a company that may tend to have a negative impact on the environment as well as monitoring other actions and sustainability initiatives of the company that may tend to have a positive impact on the environment. A company may make efforts to reduce pollution from smokestacks and/or use more efficient energy consumption systems to reduce their contribution to the environmentally harmful gas emissions. Since some companies can only reasonably reduce emissions to a certain limit, they can take other measures to compensate or counteract their negative influences on the environment. Thus, the positive contributions may be instantiated in a metric referred to as “carbon offset credits” (also referred to as “carbon credits” or “offset credits”). These carbon offset credits may represent actual carbon emissions improvements, planting of trees and other vegetation that can absorb many environmentally harmful gases, and/or simply paying a certain amount of money that goes toward other organizations that reduce carbon emissions in different ways. Thus, a company (or individual) may then purchase carbon offset credits to compensate for their own carbon emissions (carbon footprint).

In a recent news article, a popular singer and her entourage were found to be responsible for a large amount of carbon dioxide emissions as a result of usage of her private jet during a worldwide tour and return trips to the United States. However, to compensate for the unusually high carbon emissions during this time and to show concern for the environment, the popular singer's team claims to have purchased double the amount of carbon offset credits needed to more than counteract the negative effects of jet fuel emissions into the atmosphere.

For instance, according to an accounting type of scenario, one carbon offset credit is intended to represent a reduction, avoidance, or removal of one metric ton of carbon dioxide (CO₂) or carbon dioxide equivalent (CO2e). For example, one CO2e is meant to represent specific amounts of other environmentally harmful gases, such as carbon monoxide (CO), methane (CH₄), nitrous oxide (N₂O), ozone (O₃), etc. In some market trade scenarios, one carbon offset credit may be worth between about $40 and $80. Carbon offset credits can also take the form of a type of promissory note, where a company promises that environmental initiatives are to take place in the future to offset, eliminate, or counteract current carbon emissions.

There are a variety of projects or initiatives that allow an organization to reduce environmentally harmful gases (often referred to as “greenhouse gases”). For example, some projects may involve reforestation (i.e., planting new trees and saplings), planting other types of vegetation, eliminating or reducing deforestation or removal of existing trees and vegetation, reduction of energy production plants that spew harmful gas emissions, introduction or building of renewable energy projects (e.g., wind farms, biomass energy, biogas digesters, hydroelectric dams, etc.), utilization of more energy efficient projects (e.g., nuclear fusion plants, more efficient kitchen appliances, etc.), and others.

A problem with the current system, however, is that the systems and methods for monitoring the level of the negative impact that carbon emissions have on the environment as well as monitoring the level of the positive impact that green initiatives have on the environment are difficult to achieve. Also, companies and individuals can make claims about their environmental initiatives, even though these claims cannot be easily verified. Therefore, there is a need for a trusted entity or certification system (e.g., a trusted third party, such as DigiCert) to work in coordination with reputable environmental monitoring groups (e.g., the Environmental Protection Agency (EPA), etc.) to enable companies to present their environmental claims in a verifiable manner. That is, the certification systems can issue digital certificates that include or embed certifiable information about the actual good (or harm) that a company is doing to the environment, whereby the public can easily identify which companies are actually making a difference in efforts to reduce CO₂ emissions, reverse global warming trends, and practice policies that are helpful to the health of the environment.

The systems and methods of the present disclosure pertain to the field of digital certificates (e.g., X.509 certificates), specifically to the embedding of environmental carbon offset credits within digital certificates. The systems and methods may be configured to integrate carbon offset credits directly into digital certificates, enabling organizations and other various entities to showcase their commitment to environmental responsibility, in a verifiable manner.

In one implementation, the carbon offset credits may be part of an extension of a digital certificate, X.509 certificate, or other existing form of certificate. In other embodiments, the carbon offset credits may be part of a new type of digital certificate intended specifically for the purpose of tracking carbon offset credits and related information thereof. The certificates that contain the carbon offset credit information therein may include details such as carbon offset amounts (in CO2e), the verifying organization, offset methods and/or sources, a unique identifier for external verification, and other information. In some embodiments, the digital certificates may store a unique identifier that may be used for verification and may refer to a public record (e.g., on a blockchain) that the public can use to confirm the carbon offset information, which therefore allows for independent verification.

The generation of applicable digital certificates in this regard (i.e., storing carbon offset credits, carbon emission information, sustainability initiatives, etc.) enables the integration of this information with various digital platforms. Certificate Authorities (CAs), such as DigiCert, may be configured to generate and issue these digital certificates. In addition, the CAs can collaborate with environmental organizations for third-party verification of achieved offsets, ensuring transparency and authenticity.

When a company has been issued such a digital certificate with the embedded carbon offset information, the company can then display the certificate for the public to see. In addition to regular certificate display markings, special carbon offset emblems, markings, seals, etc. can be presented to increase the public awareness of environmental concerns.

In some embodiments, these digital certificates may be applicable for a limited amount of time and may be renewed when a certain time period has passed. In this way, the effectiveness of new energy-friendly systems can be monitored again to determine how well the new systems may be working and to get up-to-date information. Also, renewals may be needed for monitoring aging equipment to evaluate new and old systems for energy efficiency. The systems and methods may test to ensure that offsets remain valid. For renewals, this may include the recalculation of the carbon costs, embedding corresponding offsets in the renewed certificate, etc. In some cases, it may be necessary to revoke a digital certificate if it is found that a company is no longer following environmentally friendly policies, has abandoned promised green initiative, etc.

The digital certificates described in the present disclosure may be stored in any suitable form for secure digital transport to the certificate recipient. For example, digital certificates may be stored or verified in a decentralized digital ledger, such as blockchain. That, the digital certificate can be securely encrypted and stored in an unalterable way. Also, the carbon offset credits, which can have specific market value that can be traded in a cap-and-trade system, can be securely recorded in the ledger or blockchain file. In this carbon offset credit ecosystem, records of buying and selling of this digital asset can be safely stored.

### System for Managing Carbon Offset Credits

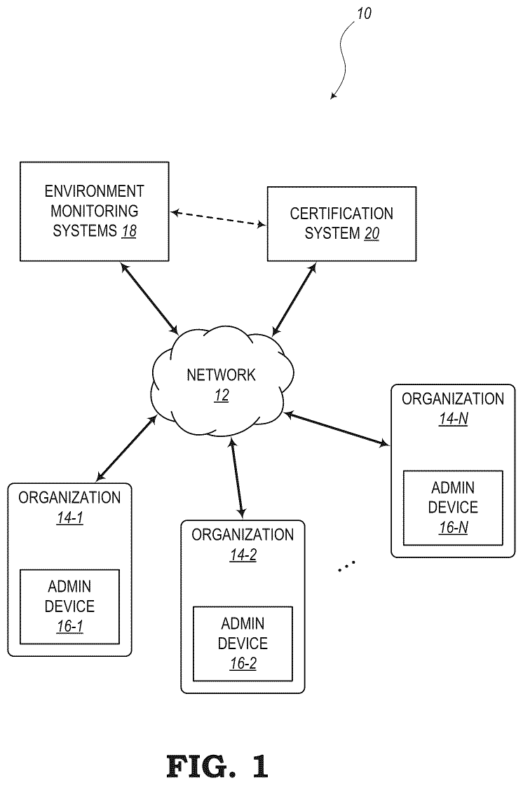

FIG. 1 is a diagram showing an embodiment of a communications system 10 in which digital certificates associated with carbon offset credits can be issued to a plurality of organizations. As illustrated in this simplified embodiment, the communications system 10 includes a network 12 (e.g., the Internet) over which computing devices can communicate. The communications system 10 further includes a plurality of organizations 14-1, 14-2, . . . , 14-N, where each organization 14 may have one or more admin devices 16-1, 16-2, . . . , 16-N and/or other computing devices that may be configured to access the network 12. Also, the communications system 10, as shown, includes one or more environment monitoring systems 18 and a certification system 20.

Each admin device 16 may be a computing device that is used by an admin or other representative of a respective organization 14. The admin devices 16 may allow the representative to make a request for a digital certificate from the certification system 20, receive a digital certificate once it is issued, and perform other activities. Each organization 14 may be any type of business, company, organization, enterprise, government agency, private agency, public entity, private entity, etc. In particular, each organization 14, whether they are involved with manufacturing, personal service, online service, and/or other types of operations, will inherently have some type of “carbon footprint.” For example, every organization 14 will invariably use a certain amount of power or energy for conducting business (e.g., powering a manufacturing line, running lights, powering computers, etc.). Some organizations 14 may even use a manufacturing process that involves the emissions of environmentally harmful gases (often referred to as “greenhouse gases”), particularly involving the burning of fossil fuels. As a result, each organization 14 may be responsible for contributing to the issue of polluting the atmosphere to some degree. As mentioned above, some policies have been put in place to reduce the emission of carbon dioxide (CO₂) and other environmentally harmful gases (e.g., carbon monoxide (CO), methane (CH₄), nitrous oxide (N₂O), ozone (O₃), chlorofluorocarbons, hydrofluorocarbons, perfluorocarbons, etc.), which can result in the “greenhouse effect,” trapping heat in the Earth's atmosphere and causing global warming.

The one or more environment monitoring systems 18 may include any government-run or privately-run organizations or agencies that regulate, monitor, and enforce policies regarding the emissions of environmentally harmful gases. These environment monitoring systems 18, for example, may include the Environmental Protection Agency (EPA), the newly created US Greenhouse Gas Measurement, Monitoring, and Information System (US GHGMMIS), among others. The environment monitoring systems 18 may test or monitor the carbon emissions of the various organizations 14-1, 14-2, . . . , 14-N. The environment monitoring systems 18 may monitor and regulate carbon emissions as well as “carbon offsets,” which are actions taken to counteract or offset the negative effects of the environmentally harmful gases (or “greenhouse gases”). In essence, the organizations 14 may be permitted to emit a certain amount of carbon dioxide as long as they also make efforts to offset these emissions with green initiatives.

In addition, the certification system 20 is a trusted third-party entity (e.g., DigiCert) that is configured to generate and issue digital certificates for various purposes. Regarding the embodiments of the present disclosure, the certification system 20 is configured to generate and issue a specific type of certificate in which carbon offset credits can be embedded. In some embodiments, this may be a unique type of certificate for this particular purpose. In other embodiments, the carbon offset credits can be embedded in another type of digital certificate (e.g., existing types of certificates) used for other purposes (e.g., website security certificates, email certificates, identity certificates, etc.).

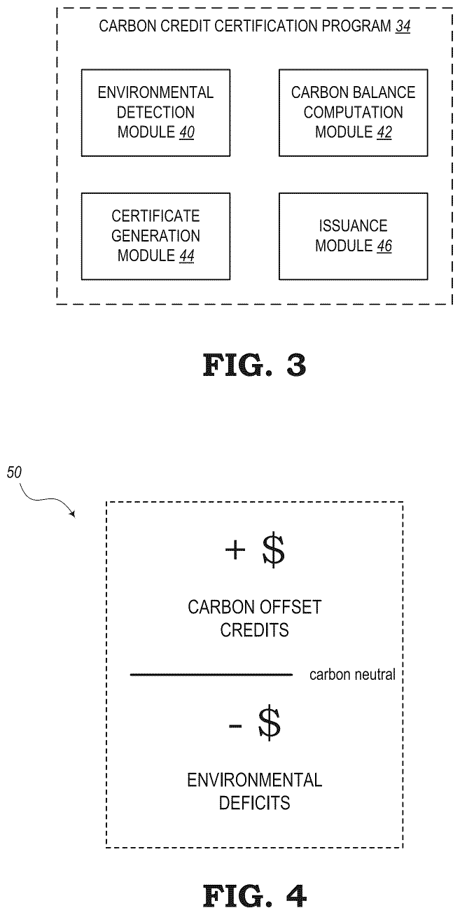

The environment monitoring systems 18 and certification system 20 may be configured to operate together in some respects. They may communicate directly with each other and/or communicate via the network 12. In particular, the certification system 20 may receive information regarding the status of each organization 14 with respect to carbon emissions, carbon offset initiatives, carbon offset credits, etc. The certification system 20 can then use this information to generate appropriate certificates that have the actual carbon offset credit information embedded therein and other information indicating the status of an organization 14 with respect to their environmental responsibleness, environment account balance (FIG. 4), etc.

### Certification System

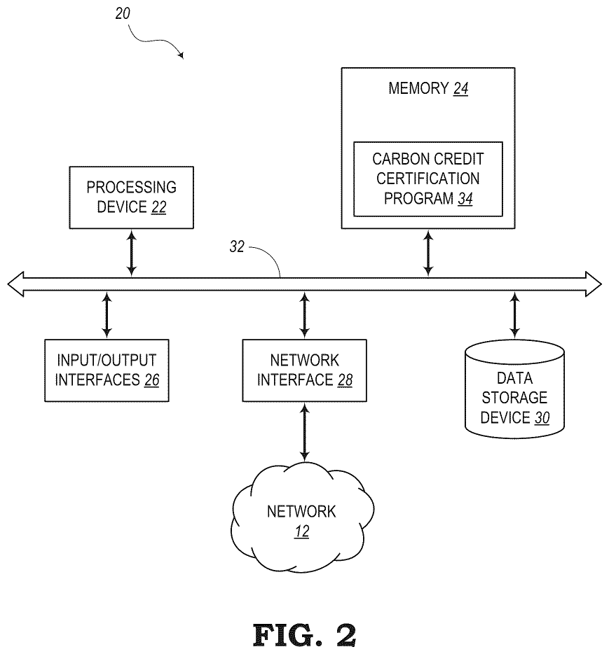

FIG. 2 is a block diagram illustrating an embodiment of the certification system 20 shown in FIG. 1. The certification system 20 may be a digital computer that, in terms of hardware architecture, generally includes a processing device 22, memory 24, input/output (I/O) interfaces 26, a network interface 28, and a data storage device 30. It should be appreciated by those of ordinary skill in the art that FIG. 2 depicts the certification system 20 in a simplified manner, and a practical embodiment may include additional components and suitably configured processing logic to support known or conventional operating features that are not described in detail herein. The components (22, 24, 26, 28, 30) are communicatively coupled via a local interface 32. The local interface 32 may be, for example, but not limited to, one or more buses or other wired or wireless connections, as is known in the art. The local interface 32 may have additional elements, which are omitted for simplicity, such as controllers, buffers (caches), drivers, repeaters, and receivers, among many others, to enable communications. Further, the local interface 32 may include address, control, and/or data connections to enable appropriate communications among the aforementioned components.

The processing device 22 is a hardware device for executing software instructions. The processing device 22 may be any custom made or commercially available processor, a Central Processing Unit (CPU), an auxiliary processor among several processors associated with the certification system 20, a semiconductor-based microprocessor (in the form of a microchip or chipset), or generally any device for executing software instructions. When the certification system 20 is in operation, the processing device 22 is configured to execute software stored within the memory 24, to communicate data to and from the memory 24, and to generally control operations of the certification system 20 pursuant to the software instructions. The I/O interfaces 26 may be used to receive user input from and/or for providing system output to one or more devices or components.

The network interface 28 may be used to enable the certification system 20 to communicate on a network, such as the Internet. The network interface 28 may include, for example, an Ethernet card or adapter or a Wireless Local Area Network (WLAN) card or adapter. The network interface 28 may include address, control, and/or data connections to enable appropriate communications on the network. A data storage device 30 (e.g., one or more databases, data stores, etc.) may be used to store data. The data storage device 30 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data storage device 30 may incorporate electronic, magnetic, optical, and/or other types of storage media. In one example, the data storage device 30 may be located internal to the certification system 20, such as, for example, an internal hard drive connected to the local interface 32 in the certification system 20. Additionally, in another embodiment, the data storage device 30 may be located external to the certification system 20 such as, for example, an external hard drive connected to the I/O interfaces 26 (e.g., SCSI or USB connection). In a further embodiment, the data storage device 30 may be connected to the certification system 20 through a network, such as, for example, a network-attached file server.

The memory 24 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 24 may incorporate electronic, magnetic, optical, and/or other types of storage media. Note that the memory 24 may have a distributed architecture, where various components are situated remotely from one another but can be accessed by the processing device 22. The software in memory 24 may include one or more software programs, each of which includes an ordered listing of executable instructions for implementing logical functions. The software in the memory 24 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The certification system 20 further includes a carbon credit certification program 34 that may be implemented in any suitable combination of hardware (e.g., configured in the processing device 22) and/or software/firmware (e.g., configured in the memory 24). The carbon credit certification program 34 may be stored in any suitable non-transitory computer-readable media (e.g., memory 24) and may include computer logic or code having instructions that enable or cause the processing device 22 to perform certain actions as discussed in the present disclosure.

Of note, the general architecture of the certification system 20 can define any device described herein. However, the certification system 20 is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

Embedding Carbon Offset Credits into a Digital Certificate

FIG. 3 is a block diagram illustrating an embodiment of processing modules of the carbon credit certification program 34 shown in FIG. 2. As illustrated in this embodiment, the carbon credit certification program 34 includes an environmental detection module 40, a carbon balance computation module 42, a certificate generation module 44, and an issuance module 46.

The environmental detection module 40 may be configured to receive pertinent information from one or more of the environment monitoring systems 18 and/or other sources (e.g., from the organizations 14 themselves). The received information may be related to positive contributions to the Earth's atmosphere (e.g., such as practices that reduce emissions, verifiable improvements in carbon emissions, use of more energy efficient machinery, reforestation, etc.) Also, the received information may be related to factors that negatively affect the environment (e.g., actual data of emissions of environmentally harmful gases, failure to improve or repair carbon emitting equipment, etc.). Also, in some embodiments, the environment detection module 40 may be configured to monitor this information about the organizations 14 and may work in conjunction with carbon emission detection instruments and the like.

The carbon balance computation module 42 is configured to take both the positive and negative details obtained by the environmental detection module 40. From this information, the carbon balance computation module 42 may use various calculations, algorithms, techniques, etc. to compute a value that is intended to represent how well the monitored organization 14 is behaving with respect to environmental responsibility. This may include, for example, calculating an estimate of a value of the environmentally positive aspects of the organization 14 and subtracting an estimate of a value of the environmentally negative aspects of the organization 14. For example, the positive and negative values may be estimated in terms of metric tons of CO2e emissions that the organization 14 is responsible for and/or a monetary value of the worth of a surplus or deficit of credits (e.g., positive or negative balance of carbon offset credits), as displayed for example in FIG. 4. For example, in the current marketplace, one metric ton of CO2e (positive or negative) is worth between about $40 and $80. Thus, the calculated value can be given a certifiable worth as a digital asset.

The carbon credit certification program 34 of FIG. 3 further includes the certificate generation module 44. After determining the value, worth, or balance of the digital asset associated with the organization 14, the certificate generation module 44 is configured (e.g., upon request) to validate the legitimacy of the organization 14 as well as analyze the environmental friendliness, so to speak, of the organization 14. The certificate generation module 44 may then create a certificate that includes the environmental score or balance of the organization 14. As mentioned above, the digital certificate may be an existing type of certificate that might be used for other purposes, where, in this case, the information about the environmental score or balance can be embedded in the certificate with other information. Also, in other embodiments, the certificate generation module 44 may be configured to generate a new type of certificate dedicated exclusively to the purpose of certifying environmental responsibleness to enable the organization to showcase their accomplishments in this regard. Nex, the issuance module 46 is configured to register, issue, and/or transfer the digital certificate to the organization 14.

FIG. 4 is a diagram showing an example of an environmental account balance 50. The environment account balance 50 may be recorded and updated for each organization 14 and may be influenced by the monitoring activities of the environmental detection module 40 and carbon balance computation module 42, as described above. For example, the environment monitoring systems 18 may be configured to keep score, as it were, to determine an environment account that considers both the negative aspects (e.g., amounts of carbon emissions) and the positive aspects (e.g., improvements in manufacturing processes to reduce emissions, reforestation programs, etc.). This information can be provided to the environmental detection module 40 to create the environmental account balance 50. Based on various calculations, each organization 14 may be carbon neutral (i.e., having an equal balance of carbon emissions and countermeasures to offset those carbon emissions) or may be positive or negative in their balances. A positive balance equates to a “carbon offset credit” (i.e., providing more carbon offsets than carbon emissions). A negative balance equates to environmental liabilities or deficits (i.e., producing more harmful emissions than carbon offsets). The environmental account balance 50 may be a theoretical value (for showcasing environmental integrity and/or for bragging rights), or, in a more concrete scenario, may have actual market value that can be traded as a commodity or digital asset.

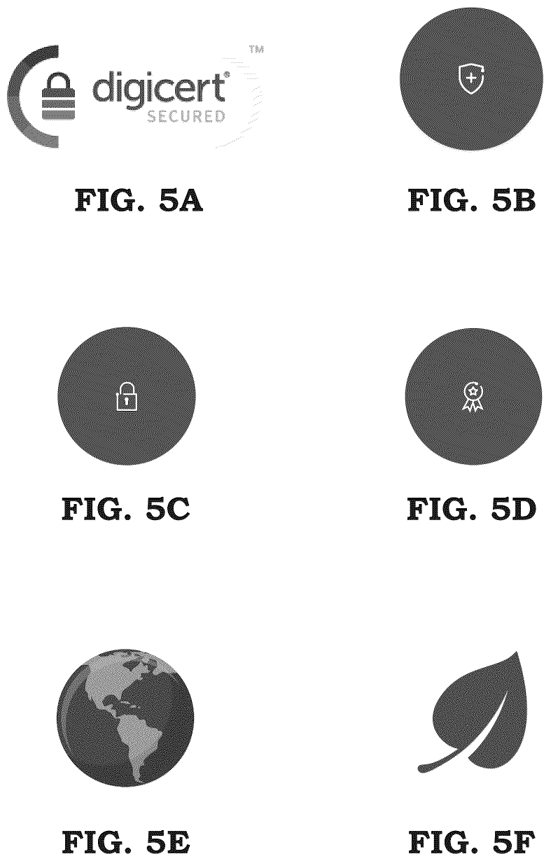

FIGS. 5A-5F are examples of possible markings that may be used for indicating information associated with carbon offset credits of an organization 14. For instance, when an organization 14 receives a digital certificate with environmental carbon offset credit information included or embedded therein, they be given an opportunity to display one or more of the markings of FIGS. 5A-5F on their websites, publications, etc. to demonstrate their commitment to environmental initiatives. The markings of FIGS. 5A-5F may be depicted as seals, emblems, tokens, badges, crests, symbols, insignia, icons, etc. for communicating concern for environmental issues to the public. In particular, FIG. 5A is an example of a marking that may be issued by DigiCert, a trusted third-party certification company. FIG. 5B is an example of a marking of a shield. FIG. 5C shows an example of a lock emblem. FIG. 5D shows an example of a badge icon. FIG. 5E shows an example of an Earth symbol that may be presented for indicating Earth friendliness. FIG. 5F shows an example of a green leaf that may be presented for indicating commitment to green initiatives.

In some embodiments, the certification system 20 may provide a QR code to the organization 14, allowing the public to access information of the details of environmental monitoring and success to provide a transparent view of the organization's environment influencing practices. It should also be noted that the examples of FIGS. 5A-5F are not meant to be limiting but are simply intended to show various possibilities where endless other implementations are contemplated and may be used with respect to the embodiments of the present disclosure.

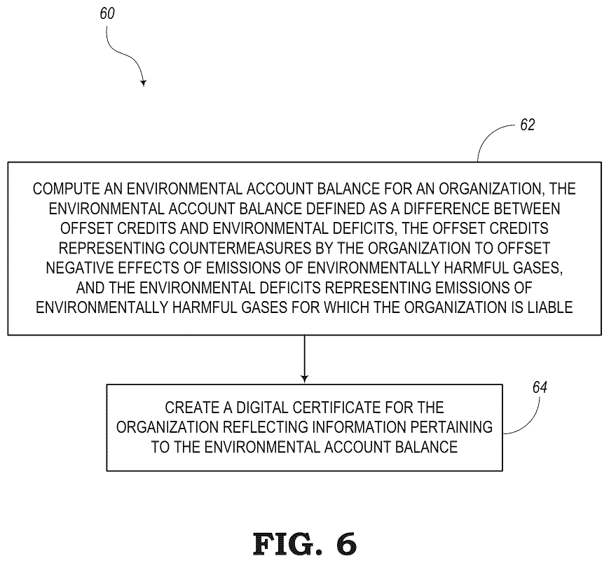

FIG. 6 is a flow diagram illustrating an embodiment of a method 60 for embedding carbon offset credits in a digital certificate. As shown in FIG. 6, the method 60 includes a step of computing an environmental account balance for an organization, as indicated in block 62. In particular, the environmental account balance is defined as a difference between offset credits and environmental deficits, where the offset credits represent countermeasures by the organization to offset negative effects of emissions of environmentally harmful gases, and the environmental deficits represent emissions of environmentally harmful gases for which the organization is liable. Furthermore, the method 60 includes a step of creating a digital certificate for the organization reflecting information pertaining to the environmental account balance, as indicated in block 64. According to some embodiments, the method 60 may be stored in non-transitory computer-readable media and executed by a processing device (e.g., processing device 22) and/or may be performed by the certification system 20.

In some embodiments of the method 60, the information pertaining to the environmental account balance may include a carbon offset surplus configured as a digital asset having market or trade value. Also, the method 60 may include a step of adding an identifier in the digital certificate that references one or more decentralized digital ledgers verifying the environmental account balance. According to some embodiments, the method 60 may be performed by the certification system 20 that works in collaboration with one or more environment monitoring systems 18 for monitoring and/or enforcing policies regarding emissions of the environmentally harmful gases.

The environmental deficits (block 62) may be defined by a carbon dioxide equivalent (CO2e) metric. The environmentally harmful gases, for example, may include carbon dioxide and/or so-called “greenhouse gases.” In some embodiments, the method 60 may further include a step of issuing the digital certificate to an admin device (e.g., admin device 16) associated with the organization 14. The digital certificate, for example, may be accompanied by one or more seals, marks, badges, or QR codes allowing the organization to showcase third-party verification of their commitment to environmental responsibility and green initiatives.

The digital certificate, according to some implementations, may be further configured for authenticating identity and/or security of the organization. In this case, the method 60 may include a step of embedding the information pertaining to the environmental account balance into the digital certificate thereby extending the utility of the digital certificate. In other embodiments, the digital certificate may be a carbon offset credit certificate and/or may be created in accordance with X.509 policies.

### Example Use Case Regarding a Data Center

According to the following example, suppose one of the organizations 14 is a data center that houses hundreds of servers and other equipment in a temperature controlled environment. The example looks at how the data center can be more environmentally responsible, such as by minimizing power consumption, optimizing HVAC systems, etc.

The certification system 20 may be configured to deconstruct a Public Key Infrastructure (PKI) process into its constituent operations and assign a carbon cost to each of these operations. Then, the certification system 20 may sum them up to arrive at a carbon cost estimate for issuing a PKI certificate to the owner of the data center.

Regarding the certificate generation (e.g., certificate generation module 44), the certification system 20 may determine a computational cost (e.g., using the carbon balance computation module 42), such as by using algorithms involved in PKI (e.g., Rivest Shamir Adleman (RSA), Elliptic Curve Cryptography (ECC), etc.). The carbon balance computation module 42 may use varying amounts of computational power needed to generate keys and sign certificates. For instance, an RSA 2048-bit key might require more computational power than ECC.

Also, the environmental detection module 40 may be configured to determine energy consumption of the data center. Once computational cost has been estimated, this could be related to the energy consumption of server hardware with respect to consumption benchmarks related to the specific cryptographic operations.

Regarding infrastructure and maintenance of the data center, the environmental detection module 40 may gather information of the operations of the servers and determine, for example, if they operate 24/7. Even in an example where the certification system 20 itself is being monitored, the environmental detection module 40 may be configured to evaluate operations with respect to managing certificate requests, revocation of digital certifications, renewals of digital certificates, etc. From this information, the carbon balance computation module 42 may be configured to determine energy consumption that contributes to the carbon footprint of the organization as well as ways to reduce energy consumption.

Furthermore, data centers often require cooling systems and other infrastructure to maintain the facility. Depending on the efficiency and source of power, this can add to the carbon footprint. Also, the transmission of electrical and optical signals through transmission lines for moving data contributes to energy usage and the carbon footprint. Again, with respect to analysis of the certification system 20 itself, every time a certificate is fetched, validated, or checked against a Certificate Revocation List (CRL), data is transmitted across the network 12, which adds to the carbon cost.

Continuing with the data center example, the selection of energy sources can also be a consideration with respect to effect toward better environmental practices. Different energy sources have different carbon footprints. If the data center and/or servers running PKI operations are powered by renewable energy, then the carbon cost will be lower compared to one powered by fossil fuels. The certification system 20 (in cooperation with the environment monitoring system 16) may be configured to use available benchmarks and studies to assess environmental deficits and offsets more accurately. They may look for, consider, and put into practice existing research and studies on the carbon cost of computational operations, data transmission, and server maintenance.

### X.509 Certificate

A certificate authority is an entity that stores, signs, and issues digital certificates. This allows others (relying parties) to rely upon signatures or on assertions made about the private key that corresponds to the certified public key. A CA acts as a trusted third party-trusted both by the subject (owner) of the certificate and by the party relying upon the certificate. For certificate authorities, existing individual validation processes involve the use of third-party verification services to validate basic individual information such as first name, last name, professional title, etc.

X.509 certificates are defined by ITU X.509, Information technology-Open Systems Interconnection—The Directory: Public-key and attribute certificate frameworks, October 2019, the contents of which are incorporated by reference in their entirety. An X.509 certificate binds an identity to a public key using a digital signature. A certificate contains an identity (a hostname, or an organization, or an individual) and a public key (e.g., RSA, DSA, ECDSA, ed25519, etc.), and is signed by a certificate authority. X.509 also defines certificate revocation lists, which are a means to distribute information about certificates that have been deemed invalid by a signing authority, as well as a certification path validation algorithm, which allows for certificates to be signed by intermediate CA certificates, which are, in turn, signed by other certificates, eventually reaching a trust anchor. When a certificate is signed by a trusted certificate authority, or validated by other means, someone holding that certificate can use the public key it contains to validate documents or content digitally signed by the corresponding private key.

In an embodiment, an X.509 certificate can be used to digitally sign content. A content signing certificate allows individuals, teams, and organizations to add an electronic, digital signature to a document or other content in a variety of file formats to prove ownership. The digital signature is an encrypted hash of your message that can only be decrypted by someone who has a copy of your public key, which ensures (1) content stays unaltered, (2) the creator's identity is confirmed, and the like.

In another embodiment, the X.509 certificate can be referred to as a personal certificate, i.e., it does not necessarily need to be used to digitally sign content. In a further embodiment, the X.509 certificate can be a content credential that includes history and identity data attached to content. A user can view this data when a creator or producer has attached it to content to understand more about what has been done to it, where it has been, and who is responsible. Content credentials are public and tamper-evident, and can include info like edits and activity, assets used, identity info, and more.

### CONCLUSION

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A certification system comprising:
a processing device; and
memory configured to store computer logic having instructions that enable the processing device to perform steps of
computing an environmental account balance for an organization, the environmental account balance defined as a difference between offset credits and environmental deficits, the offset credits representing countermeasures by the organization to offset negative effects of emissions of environmentally harmful gases, and the environmental deficits representing emissions of environmentally harmful gases for which the organization is liable, and
creating a digital certificate for the organization reflecting information pertaining to the environmental account balance.

2. The certification system of claim 1, wherein the information pertaining to the environmental account balance includes a carbon offset surplus configured as a digital asset having market or trade value.

3. The certification system of claim 1, wherein the instructions further enable the processing device to add an identifier in the digital certificate that references one or more decentralized digital ledgers verifying the environmental account balance.

4. The certification system of claim 1, wherein the instructions further enable the processing device to collaborate with one or more environment monitoring systems for monitoring and/or enforcing policies regarding emissions of the environmentally harmful gases.

5. The certification system of claim 1, wherein the environmental deficits are defined by a carbon dioxide equivalent (CO2e) metric.

6. The certification system of claim 1, wherein the environmentally harmful gases include carbon dioxide and/or so-called greenhouse gases.

7. The certification system of claim 1, wherein the instructions further enable the processing device to perform a step of issuing the digital certificate to an admin device associated with the organization.

8. The certification system of claim 1, wherein the digital certificate is accompanied by one or more seals, emblems, tokens, badges, crests, symbols, insignia, icons, or QR codes allowing the organization to showcase third-party verification of their commitment to environmental responsibility and green initiatives.

9. The certification system of claim 1, wherein the digital certificate is further configured for authenticating identity and/or security of the organization, and wherein the instructions further enable the processing device to embed the information pertaining to the environmental account balance into the digital certificate thereby extending a utility of the digital certificate.

10. The certification system of claim 1, wherein the digital certificate is a carbon offset credit certificate.

11. The certification system of claim 1, wherein the digital certificate is created in accordance with X.509 policies.

12. A method comprising steps of:
computing an environmental account balance for an organization, the environmental account balance defined as a difference between offset credits and environmental deficits, the offset credits representing countermeasures by the organization to offset negative effects of emissions of environmentally harmful gases, and the environmental deficits representing emissions of environmentally harmful gases for which the organization is liable; and
creating a digital certificate for the organization reflecting information pertaining to the environmental account balance.

13. The method of claim 12, wherein the information pertaining to the environmental account balance includes a carbon offset surplus configured as a digital asset having market or trade value.

14. The method of claim 12, further comprising a step of adding an identifier in the digital certificate that references one or more decentralized digital ledgers verifying the environmental account balance.

15. The method of claim 12, further comprising a step of collaborating with one or more environment monitoring systems for monitoring and/or enforcing policies regarding emissions of the environmentally harmful gases.

16. The method of claim 12, wherein the environmental deficits are defined by a carbon dioxide equivalent (CO2e) metric.

17. The method of claim 12, further comprising a step of issuing the digital certificate to an admin device associated with the organization, wherein the digital certificate is a carbon offset credit certificate created in accordance with X.509 policies.

18. A non-transitory computer-readable medium configured to store computer logic having instructions that enable a processor to:
compute an environmental account balance for an organization, the environmental account balance defined as a difference between offset credits and environmental deficits, the offset credits representing countermeasures by the organization to offset negative effects of emissions of environmentally harmful gases, and the environmental deficits representing emissions of environmentally harmful gases for which the organization is liable; and
create a digital certificate for the organization reflecting information pertaining to the environmental account balance.

19. The non-transitory computer-readable medium of claim 18, wherein the digital certificate is accompanied by one or more seals, emblems, tokens, badges, crests, symbols, insignia, icons, or QR codes allowing the organization to showcase third-party verification of their commitment to environmental responsibility and green initiatives.

20. The non-transitory computer-readable medium of claim 18, wherein the instructions further enable the processor to embed the information pertaining to the environmental account balance into the digital certificate having other utility thereby extending a utility of the digital certificate.
